(19) United States
(12) Patent Application Publication
(10) Pub. No.: US 2011/0320329 A1
(43) Pub. Date: Dec. 29, 2011

(54) PROCESS AND SYSTEM FOR PROVIDING REAL-TIME PROCESSING SERVICE

(76) Inventors: Arjun Shetty, Chennai (IN); Rati Ranjini Rajkumar, Chennai (IN); Adhil Shetty, Chennai (IN); Isac Iype, Chennai (IN); Vivekananthamoorthy Vimal Kumar, Chennai (IN); R. V. Ramanathan, Chennai (IN); Rameswaran Sankara, Chennai (IN)

(21) Appl. No.: 13/056,832

(22) PCT Filed: Jul. 31, 2009
(86) PCT No.: PCT/IN09/00437

§ 371 Date: Mar. 7, 2011

(30) Foreign Application Priority Data
Jul. 31, 2008 (IN) 1834/CHE/2008

(51) Int. Cl. G06Q 40/00

(52) U.S. Cl. 705/35

(57) ABSTRACT

The present invention relates to a process and system for providing real-time processing service is described. In one embodiment, the process includes selecting a service as desired by an applicant, submitting a preliminary application for extracting available offers associated with the selected service, extracting the available offers associated with the selected service by processing information provided in the preliminary form; displaying the extracted available offers; selecting at least one offer from said extracted available offers by the applicant, submitting a dynamic application for said at least one available offer selected by the applicant, authenticating information provided in the dynamic application instantly, and routing the authenticated application to a respective firm. In another embodiment, a system for providing real-time processing service includes an application server container and a file system/database wherein the business rules are encrypted which is password protected.

### FIELD OF THE INVENTION

The present invention generally relates to service management. Particularly, the present invention relates to a process and system for providing real-time processing service in an efficient single integrated interface.

### BACKGROUND OF THE INVENTION

Currently, there are multiple firms dealing in diverse services (services based on asset products, liability products, insurance products etc.). These firms offer their services depending upon the requirement and eligibility of the applicants. In the existing scenario in order to procure any related services of the firm, an applicant based on his requirement, needs to speak to a representative of each firm and fills in their application forms in order to find out the offers that are available as per the requirement. Thus, the process is tedious, time consuming and also the outcome may not be always positive.

For example, if one desires to apply for a personal loan, he has to meet different firms' representatives or fill in various forms to retrieve information with respect to a loan amount offered by each firm, their interest rates etc. Once the applicant gets the information from various firms, he finds it hard to compare the offers, because of the complexity within the offers that are provided (for example, firms may quote their interest rates as an annual reducing balance rate or a quarterly reducing balance rate or a monthly reducing balance rate or a daily reducing balance etc., while some firms may ask for a few monthly payments to be made in advance at the time of disbursement of the loan, which increases the effective interest rate being charged). Therefore, the conventional process is tedious and time consuming.

On the other side, the conventional method followed at the firms' side for processing an application has several drawbacks. Processing of an application involves verification of information which also involves several personal visits, collection of various documents etc. This involves a lot of time and also financial burden for the firm. However, in spite of this tiresome exercise many of the applications do not get approved hence resulting in unnecessary expense and waste of time.

Therefore, a single integrated process, which is both, the applicant as well as firm friendly, is needed, where the applicant can search for the best required service offers and a conventional non-productive authentication process carried out by the firm is replaced by a process which provides real-time processing service.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. The sole purpose is to present some concepts in a simplified form as a prelude to the more detailed description that is presented later.

The primary object of the present invention is to invent a process and system for providing real-time processing service in an efficient single integrated interface.

In one aspect, the present invention describes a process for providing real-time processing service including selecting the desired service, submitting a preliminary form for extracting eligible offers associated with the selected service the applicant is eligible for, displaying the extracted available offers, selecting at least one offer from said extracted offers by the applicant, filling up and submitting a dynamic application for said offer, authenticating information provided in the dynamic application instantly and routing the authenticated application to the respective firm.

Accordingly, the present invention relates to the process, wherein the service includes, but not restricted to service for asset products, insurance products, liability products such as overdraft product, credit card, mortgage, mortgage refinancing, stock brokerage, auto loan, student loan, personal loan, health insurance plan, life insurance plan, auto insurance plan, home equity loan, a credit line extension, business loan, business credit card, benefits package, margin lending products for the purchase of stocks, bonds etc.

Accordingly the present invention relates to the process, wherein the information in the preliminary form may be restricted to the information which affects the eligibility of said selected service.

Accordingly the present invention relates to the process, wherein the available offers are extracted from a database, which comprises business rules and offers of different firms wherein the business rules include, but are not restricted to credit underwriting rules, insurance underwriting rules, banking regulations etc.

Accordingly the present invention relates to the process, wherein the extracted available offers are displayed to the applicant in a simpler format, such as for a loan service comprises, but not restricted to, eligible loan amount, eligible loan tenure, EMI amount, interest rate, effective interest rate total cost of loan inclusive of finance charges and fees, details of pre-payment fees, details of pre-closure fees, average processing time, average users' rating etc.

Accordingly the present invention relates to the process, wherein the information of the displayed offers is automatically updated based on the selected offer.

Accordingly the present invention relates to the process, wherein the dynamic application is customized to the applicant's profile which comprises personal details, professional details, and the documents required.

Accordingly the present invention relates to the process, wherein the information submitted by the applicant, such as mobile phone number, email id, residence telephone number, work telephone number, residence address, duration of stay at the current address, employer name, period with current employer, salary amount, break-up of gross salary into its constituent parts, designation, periodicity of salary, number of bounced checks in bank account, payments towards existing loan obligations, bank account number, address, location of bank branch, average bank account balance, professional details, bank statement, PAN details etc. are authenticated instantly.

Accordingly the present invention relates to the process and system, wherein the status of the application is updated to the applicant via email, SMS or any other mode of available electronic communication system.

Accordingly the present relates to a system for providing real-time processing service, includes an user interface for real time processing services; various option of services to be selected through the user interface; corresponding application form for available services; dynamically processing the application for the information provided; extracting the other information stored in its database in relation to the corresponding applicant; displaying the offers available; authenticating information provided in the dynamic application instantly; and routing the authenticated application to a respective firm and updating status of the application to the applicant through an e-mail, SMS or any other mode of available communication system.

Accordingly the present invention relates to a system for providing real-time processing service, including an application server container and a file system/database wherein the business rules are encrypted which is password protected.

Accordingly the present invention relates to a system for real-time service wherein the application server container comprises of a web user interface, a business rules update manager, a rules evaluation engine and an identity/access manager.

Accordingly the present invention relates to a system wherein the web user interface provides real time services such as selection of service, displaying of offers etc; the business rules of different firms are updated in business rules update manager; extraction of eligible offers are evaluated by rules evaluation engine; and authentication of information by identity/access manager.

### BRIEF DESCRIPTION OF ACCOMPANYING DRAWINGS

Example embodiments are illustrated by way of example and not limitation in the figures of the accompanying figures, in which like references indicate similar elements and in which:

FIG. 1 is a flowchart illustrating a process for providing real-time services, in accordance with the present invention.

FIG. 2 illustrates the high level architectural block diagram of an application server with the encrypted file system, in accordance with the present invention.

Other features of the present embodiments will be apparent from the accompanying drawings and from the detailed description that follows.

### DETAILED DESCRIPTION

The preferred embodiments of the present invention will now be explained in detailed. It should be understood however that the disclosed embodiments are merely exemplary of the invention, which may be embodied in various forms. The following description are not to be construed as limiting the invention and numerous specific details are described to provide a thorough understanding of the present invention, as the basis for the claims and as a basis for teaching one skilled in the art how to make and/or use the invention. However, in certain instances, well-known or conventional details are not described in order not to unnecessarily obscure the present invention in detail.

The present invention relates to a process for providing real-time processing service in an efficient single integrated interface. The word applicant used through out the document can be, but not restricted to an individual, a group, or an organization who may be using the system either personally or on behalf of another party. The service includes, but not restricted to service for asset products, insurance products, liability products such as an overdraft product, credit card, mortgage, mortgage refinancing, mortgage, stock brokerage, auto loan, student loan, personal loan, insurance, home equity loan, credit line extension, business loan, business credit card, benefits package, margin lending products for the purchase of stocks, bonds etc. The word, “firm” used in the document can be, but not restricted to banks, banking and non banking finance corporations, stock brokerage firms, building societies, asset management firms, credit unions, consumer finance companies, investment institutions, government sponsored enterprises or an insurance company etc.

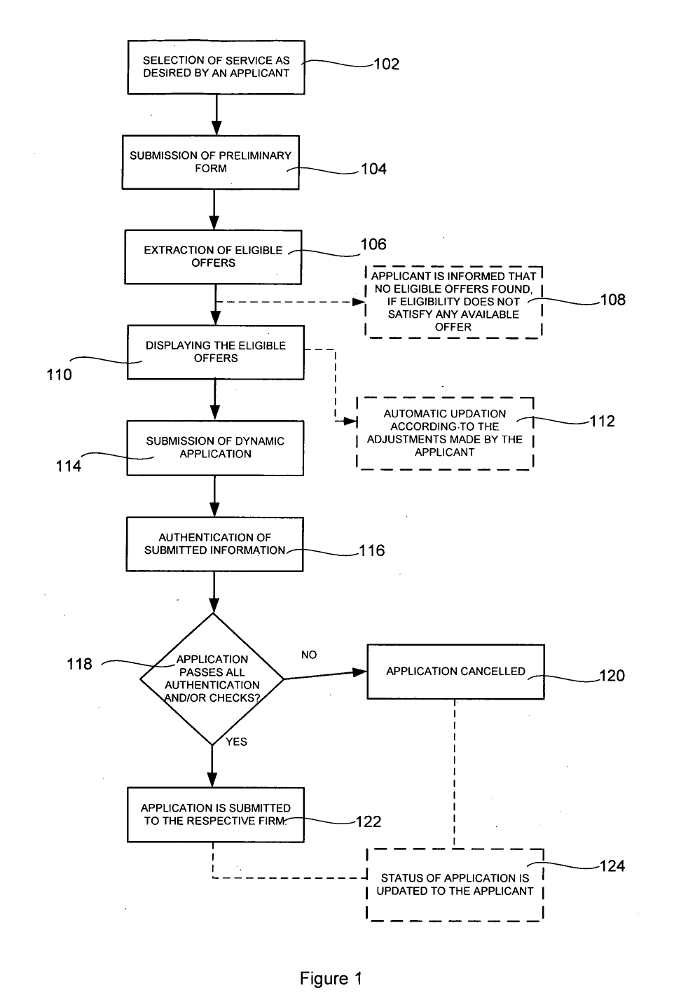

FIG. 1 is a flowchart illustrating a process for providing real-time services, in accordance with the present invention. The applicant selects one of the desired services offered by the service provider as shown in step 102. Further, the applicant fills up and submits a preliminary form for extracting available offer he is eligible for, associated with the selected service as shown in step 104. The information in the preliminary form is restricted to the information which affects the eligibility of said selected service. Optionally, other information can be retrieved from the external data sources based on the information provided on the preliminary form for further processing.

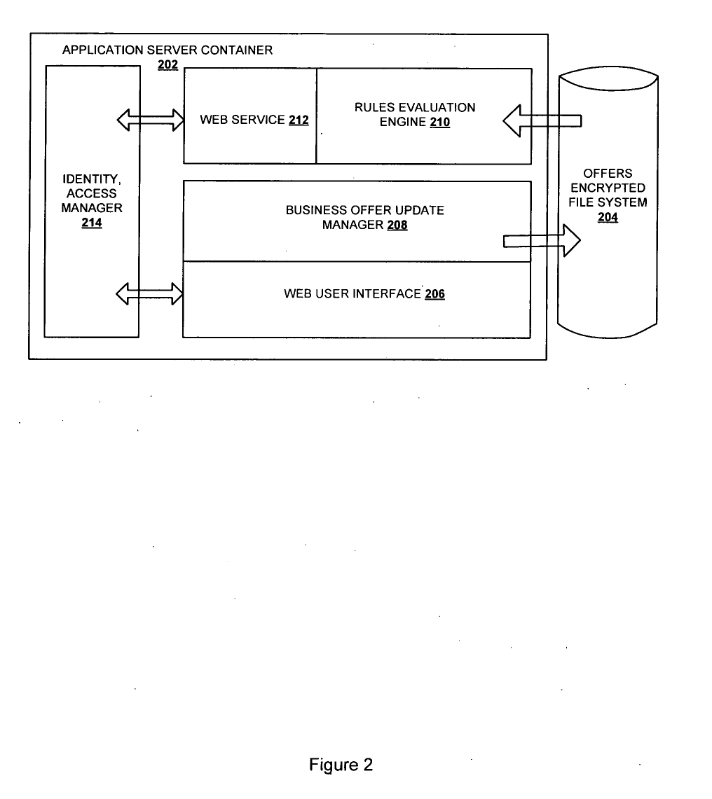

The available offers to a particular applicant are the offers associated with the selected service which are extracted based on the information provided in the application form and any other information that is retrieved from external sources as shown in step 106. However, if no offer is found, the applicant will be informed accordingly as shown in step 108. The extracted offers are displayed to the applicant as shown in step 110. The available offers are extracted from the encrypted file system/database which is illustrated in FIG. 2. In addition, the information of the displayed available offers is automatically updated based on the adjustment made by the applicant as shown in step 112. Optionally, additional information on the applicant may be retrieved from external data sources and processed based on the business rules that determine eligibility for the offer, which results into either accepting or declining the application.

Further, in order to proceed further at least one offer from said extracted available offers would be selected by the applicant and a dynamic application for said offer is submitted as shown in step 114. The information submitted in the dynamic application is authenticated instantly as shown in step 116.

The approved application which is passed through the check as shown in step 118 is routed to the respective firm as shown in step 122. However, the status of applications which is declined may be updated to the applicant through an e-mail, SMS or any other mode of available electronic communication system as shown in step 124.

For example, the above mentioned process is explained below for a personal loan service. When an applicant selects a personal loan service, a preliminary application is displayed. The required information in the preliminary application may be restricted to information used to determine the applicant's eligibility for the loan. Varied information needs to be filled in the preliminary application based on the type of employment of the applicant. Further, all available loan offers are searched from the database in the system and the eligible offer is displayed which includes eligible loan amount, eligible tenure, interest rate, effective interest rate, total cost of loan inclusive of finance charges and fees, EMI, details of pre-payment fees, details of pre-closure fees, average processing time and average users' rating etc. In addition, it allows the applicant to adjust/modify the loan amount and the tenure of the loan on the interface of the system and the list of offers will automatically be updated and the total cost/monthly payments will automatically be recalculated for the offers. In addition, the system shows the applicant, the impact of pre-paying or pre-closing the loan on the total cost of loan. In addition, in case of a loan with a floating interest rate the system allows the applicant to calculate the impact on the total cost of the loan of various scenarios where the interest rate varies. If the applicant wishes to proceed further, at least one offer from said extracted available offers is selected by the applicant and a dynamic application needs to be filled. The dynamic application includes fields such as personal details, residence address, professional details and the required document. The dynamic application also lists out the supporting documentation that the applicant needs to submit. The system enables the applicant to submit some of his supporting documentation online in a manner that prevents the documentation from being altered by retrieving them directly from the trusted data source.

In addition to the information submitted by the applicant, other information about the applicant may be retrieved from other data sources in the system including credit bureaus (for example, Credit Information Bureau (India Limited) and other data repositories (for example PAN database from Income Tax Department) and a decision on whether to decline or pass the application to the next stage may be made based on the database of offers and their respective business rules. Also, data pertaining to collateral may also be retrieved from collateral bureaus. The information submitted by the applicant is authenticated instantly by the system. Thus, the submitted information is verified in order to ensure that the submitted application has a high likelihood of converting into a disbursed loan. The various steps included in the authentication which is automated and includes like cell phone number, home telephone number, home address, stability of home address, location, employment details, employment tenure, date of birth, identity, employer etc. The authentication processes that are needed in order to approve this application are dynamic and are based on the profile of the applicant and the business rules corresponding to the offer that he has opted for. Some of the authentication procedures are illustrated below. Once the application gets through the authentication process, the application will be routed to the respective firm. Also, the status of the application will be updated to the applicant.

For instance, the cell phone number verification process is discussed herein below. When the applicant submits the application, a code is instantly messaged to the cell phone number as provided in the application form. The applicant must key in the code on the system interface in order to validate the submitted cell phone number. Validation can also be done by replying to the message. The applicant may also call the number from which the message is sent and enter a code for validation. Until this validation the application is not accepted.

Verification of home telephone number, home address and stability of home address: The Applicant is asked to call a phone number from his residence telephone number and is directed to enter a pass code by the interactive voice response unit (IVRU). Once the applicant does this, the residence telephone number is verified with high probability as it is unlikely that he will be able to make a call from someone else's residence telephone. While it is possible that a third party may enter someone else's phone number into his application form, it would be difficult for this third party to use that person's phone to make that verification call. The advantage of requiring the applicant to call a number provided by the system is that the applicant can do this at his convenience. However, if the applicant indicates that he has access to his residence telephone number at the time of filling in the application form, then the system can call the applicant automatically and request him to enter the code provided on the screen. However, if the applicant indicates that he will have access to his landline number at a particular time, then the system can call the applicant automatically at that scheduled time and request him to enter the verification code that was provided.

Also, the residence telephone number can be looked up in the phone directory (in paper or in electronic form) and it can be verified that the address corresponding to this number is the same as the residence address submitted in the application (It is to be noted that this verification is strongest if the residence phone number is registered in the applicant's name.) However the residence phone number may often be registered in the name of the applicant's relatives/spouse, who may have the same surname last name as the applicant. In addition, historic phone directories can be looked up to check how long this landline has been connected with this address i.e. how long the applicant has lived in the submitted address. Additionally, there is the possibility in change in the phone number formats, and the same can be verified by checking tenure as how long the name currently connected with this residence phone number at the address. Thereby, correctness of residence phone number and the residence address of the applicant and the time that the application has stayed at that residence are verified in a simple manner to assure the residence telephone number at any time of the day or night, at no cost and delay, thus in-person visit is not required. Note that this process can be used to validate both current and permanent residence addresses using the phone number. The proposed invented system maintains the database for verifying these checks.

The proposed invented system can securely retrieve the applicant's bank statements directly from the applicant's online bank account and automatically transmit these bank statements directly to the respective firms, which ensures the accuracy of these bank statements thus resulting in the saving of the time and cost usually spent by the firms in verification. The system requests the applicant for his online bank account credentials. Using the applicant's online bank account credentials, the system then logs into the applicant's online banking account while the applicant is on the system, downloads the applicant's current and historic bank statements and other relevant applicant information, verifies the information below within few minutes and then deletes the applicant's login credentials from the system. As a number of employers provides their employees with the option to view their salary statements online, the system can also log in to the applicant's online salary statement system in a similar fashion and directly retrieve the applicant's pay statements and automatically transmit them to the firm, which ensures the accuracy of these salary statements thus resulting in the saving of the time and cost usually spent by the firm in verification. Similarly the system can convey the applicant's credit card statements, online trading account statements etc., to the respective firm by logging in to the respective online account of the applicant using the applicant's credentials.

Further, the applicant's name, applicant's address, applicant's phone numbers and the applicant's e-mail address will be verified by the system by using the data retrieved from using online bank account. With use of fuzzy logic, it is ensured that the system can match the applicant's name in the application form with the applicant's name in the online bank account even if either of the names differs with the other because of the transpositions of first and last name, expansion of initials etc.

Most of the banks permit an access to the information of all transactions made over the past several years from their online banking accounts. The proposed invented system can download all transactions and verify the occurrence of cheque bounces: cheque bounces for each bank have a unique identifier code. The system can count the number of inward and outward check bounces and failures of standing instructions within any timeframe (ex. Last 6 months, last 3 months etc); names of current and past employers, salary details and employment stability: the system can identify salary credits by the format of these credits and can detect any discrepancies in the amount/frequency of these salary credits (In the case of a loan, the system may adjust the available loan amount accordingly). The transaction description may be used to identify the applicant's employer and the applicant's salary. The system can look at historic statements and identify how long the employee has worked with his current and previous employers; Debt: the system can identify payments used to service debt (example: payments for installment loans like auto loans are for the same amount or similar amounts every month paid to a Financial institutions) and monthly expenses. The system can identify spending patterns. This data is also used by the firms when deciding on how much credit line to extend.

The proposed invented system can download all the applicant's historic salary statements from the online salary statement system and validate details including the applicant's employer, the applicant's time in current employment, applicant's salary, break-up of applicant's salary into its components and applicant's designation at current employer. Based on these validations the system may decline the application or update the applicant's eligibility for the offer (for example: an applicant's salary may have a component for overtime pay which may not be considered by the firm when determining the loan amount he is eligible for, hence the eligible loan amount may need to be reduced) or pass the application on the next stage.

In addition, the present invention system is also tied up with some employers to verify the employment details that are submitted in the application by the applicant. When an application comes in from someone who works at one of employers listed in the database of the system, the system sends an email to a designated HR representative in that company who can verify the information submitted by the employee such as salary, employment tenure, designation etc. This verification process enables the system to verify all the important information regarding employment without needing any documentation from the applicant. Also, since the confirmation comes directly from the employer, there is no need for the firm to revalidate this information.

In yet another embodiment of the proposed invention, the applicant is requested to provide his PAN card number and the system checks the NSDL database or any other PAN card database to verify that the name and date of birth associated with the PAN number matches with the information submitted by the applicant in the application. Additionally, the system makes use of heuristics and fuzzy logic to ensure that the system can deal with initials, transpositions of first and last name when doing the name match. This verification process enables system to verify identity of the applicant with a high degree of accuracy (as PAN numbers are quite confidential and it is hard to get a hold of someone's PAN number) instantaneously and at a very low cost. The system maintains and updates various database for verification these credentials.

The system is able to connect to credit bureaus (for example Credit Information Bureau (India) Limited), collateral bureaus and other databases to collect information pertaining to the applicant (such as credit data which includes data on his obligations and his repayment history on other loans) and, in the case of a collateralized loan such as a home loan, information pertaining to the collateral offered. The system collects this data and passes it through the rules engine in the system resulting in the decision to (a) let the application pass through to the next step in the application process, (b) decline the application, or (c) hold the application in the current stage and request the applicant for more information.

The system has a huge database which contains the email domain of various employers. The database only contains domains that allow only employees of the respective company to have email ids at the domain. Whenever an applicant says that they work with one of these employers, the system asks the applicant for the portion of their work email address that precedes the @ sign (For example: if someone says they work for Microsoft, the system knows that their email address will end with ‘@microsoft.com’. So the applicant is requested to provide the portion of their email address that precedes ‘@microsoft.com’). As some employers have multiple email domains, the system can deal with this occurrence by giving applicants the option to choose any of the domains associated with this employer. The system then sends verification email to the provided email id and request the applicant to either click on a link in the email, or to feed in the verification code into the system which is provided. with the email for verification. As only employees of the company could have an email id at this domain, this check enables the system to validate with a high probability that the applicant works at that particular company. While the applicant could theoretically have asked a friend working in that company to verify his application, it is unlikely that his friend would agree to this as it puts his employment at risk. As the email usually has some portion of the employee's name in it, the system can even verify that the email id belongs to the applicant and not to a friend who works at that firm. The system validates the employer of an applicant almost instantly and at no extra cost. In case the applicant works for an employer whose email domain is not in the database, the system can also instantly validate whether the domain provided by the applicant matches the employer provided by the applicant.

The Firms have identified areas where they do not wish to extend their services. These ‘negative areas’ sometimes encompass entire PIN codes or zip codes, and sometimes they are much smaller areas which have very poor housing quality or have very poor access from a main road. In case an applicant resides in a PIN/zip code where there are negative areas, the system has the ability to look up satellite photos of the applicant's address and use this to make a determination on whether the applicant is residing in a negative area.

The system has an in-built database of the phone number prefixes of all the major employers in the country. When an applicant says that he works at one of these employers, the system checks to see that his work phone number has a prefix that matches the prefix expected for his employer. If this match succeeds, the system would ask the employee to call the system from this number and type in a code, thus validating that he has access to a phone belonging to this employer, which indicates with a high probability that he is an employee of this company. The system will also check all phone directories (in paper or on a digital medium or online) to validate that the phone number belongs to the employer with whom the applicant claims to works with.

The application passes through verification process wherein the system submits the completed pre-washed application to the selected financial institution. Alternatively, if the application does not clear verification process, the applicant is asked to provide correct information to re-verify the application. On the system, the applicant can schedule the time and location at which the supporting documents should be picked-up by the Firm. The system sends applicant a pick-up reminder via SMS, email or any other available mode of communication system at various times before the scheduled time and requires the applicant to inform the system in order to reschedule if required. The Firms picks up supporting documents and runs Credit Evaluation and Field investigation.

FIG. 2 illustrates the high level architectural block diagram of an application server with the encrypted file system/database, in accordance with the present invention. The application server container (202) and encrypted file system/database (204) are connected as shown in FIG. 2. The application server container (202) is coupled with web user interface (206), a business offer update manager (208), a rules evaluator (210), a web service (212) and an identity access manager (214). The application server container (202) is a process that runs using an exclusive secure user account of the operating system which prevents other users from snooping into its files or memory space. The only interface out of the application container (202) is the web user interface (206) and the web service (212) available to the firm who provides service.

The business rules of various firms are encrypted on file system/database (204), which are password protected and not shared with the outsiders. The business offers update manager (208) has read/write access to the database (204).The rules evaluation engine (210) has read access to it. No other user/application has access to the rules database (204). The business offers update manager (208) controls the updates to the rules in the business rules database (204). The web user interface (206) is a part of the update manager. It authenticates the offer managers using the identity/access management service (214). The rules evaluator (210) is the key engine that runs the business rules for any applicant eligibility criterion. It has a read-only access to the business rule database (204). The web service (212) provides a tight interface to the present system. The present system feeds in the eligibility criterion through the web service to get back the list of products.

An interface in the process allows firms to program their business rules (For example: credit underwriting rules, insurance underwriting rules etc.) directly into it. The proposed process functions in such a way that when the applicant's data/requirement are fed into it, it displays a list of eligible offers as an output. The applicant's data that is entered into the application includes data provided by the applicant, as well as data that may be retrieved from external data sources (for example credit bureaus, collateral bureaus, defaulter lists, business databases). Said feature is one of the key enablers of the process as many firms are unwilling to share their business rules even when a non-disclosure agreement (NDA) and policy protecting their intellectual property is in place. Hence, said feature in the process enables rules/guidelines/policies of firms to be automated and used by the system while preventing anyone other than the respective firm from even deciphering or reading these rules.

It is advantageous that the applicant receives exact customized offers online within few minutes without meeting firm's representatives and also without giving out complete information. The terms of service offers are transparent despite complexity in the offers. The entire process is extremely fast in terms of processing of application. The process is not only advantageous to the applicant but also to the firms that offer services where they are able to screen large number of applications in least time resulting in lower operational costs. Automated authentication of information provided by the applicant, prevent fraud applicants.

While the embodiments of the present invention have been illustrated with respect to an example of a personal loan service, it will be clear that the present invention and its advantages are not limited to these embodiments only. With minor modifications, substitutions and equivalents will be apparent to those skilled in the art without departing from the spirit and scope of the present invention as described in the claims. Accordingly, the specification and figures are to be regarded as illustrative examples of the invention, rather than in restrictive sense.

We claim:

1. A process for providing real-time processing service, comprising steps of:
a. selecting at least one services as desired by an applicant;
b. providing the required information in the selected application form;
c. submitting the application form for extracting available offers;
d. extracting the available offers associated with the selected service by processing information provided in the application form and information retrieved from other data sources based on the information provided in the application form;
e. selecting at least one offer from the displayed extracted available offers by the applicant;
f. submitting the dynamic application form for at least one available offer selected by the applicant;
g. authenticating information provided in the dynamic application instantly; and
h. routing the authenticated application to a respective firm and updating status of the application to the applicant through an e-mail, SMS or any other mode of available communication system.

2. The process as claimed in claim 1, wherein the service comprises, but not restricted to service for asset products, insurance products, liability products such as an overdraft product, credit card, mortgage, mortgage refinancing, mortgage, stock brokerage, auto loan, student loan, personal loan, insurance, home equity loan, credit line extension, business loan, business credit card, benefits package, margin lending products for the purchase of stocks, bonds etc.

3. The process as claimed in claim 1, wherein the information in the application form is restricted to the information which affects the eligibility of said selected service.

4. The process as claimed in claim 1, wherein processing the information further comprises retrieving the information provided in the application form.

5. The process as claimed in claim 1, wherein the available offers are extracted from a database, which comprises encrypted business rules and offers of different firms.

6. The process as claimed in claim 1, wherein the extracted available offers are displayed to the applicant in a simpler format, such as for a loan service, displayed information comprises, but not restricted to, eligible loan amount, eligible loan tenure, EMI amount, total cost of loan inclusive of finance charges and fees, average processing rate, average users' rating.

7. The process as claimed in claim 8, wherein the information of the displayed available offers are automatically updated based on the selected eligible offer.

8. The process as claimed in claim 1, wherein the dynamic application is customized to the applicant's profile which comprises personal details, residence address, professional details and the documents required.

9. The process as claimed in claim 1, wherein the information submitted by the applicant, such as mobile phone number, email id, residence telephone number, work telephone number, residence address, duration of stay in current address, employer name, salary, periodicity of salary, number of bounced checks in salary account, payments towards existing loan obligations, address, location of the firm, average bank account balance, professional details, bank statement, PAN details etc. are authenticated instantly.

10. A system for providing real-time processing service, comprising of:
a. An user interface for real time processing services;
b. various option of services to be selected through the user interface;
c. corresponding application form for available services;
d. dynamically processing the application for the information provided;
e. extracting the other information stored in its database in relation to the corresponding applicant;
f. displaying the offers available;
g. authenticating information provided in the dynamic application instantly; and
routing the authenticated application to a respective firm and updating status of the application to the applicant through an e-mail, SMS or any other mode of available communication system.

11. The system as claimed in claim 10, wherein the system comprises an application server container and a file system/database wherein the business rules are encrypted which is password protected.

12. The system as claimed in claim 11 wherein the application server container comprises: web user interface providing real time services such as selection of service, displaying of offers etc; updating the business rules of different firms by the business rules update manager; extraction of eligible offers are evaluated by rules evaluation engine; and authentication of information by identity/access manager.

13. A process and system for providing real-time processing service as herein described with reference to the accompanying drawings.
